(19) United States
(12) Patent Application Publication
(10) Pub. No.: US 2003/0185380 A1
(43) Pub. Date: Oct. 2, 2003

(54) Interactive telephone reply system

(76) Inventor: Pablo Garin, Vitoria (ES)

Correspondence Address: MUSERLIAN AND LUCAS AND MERCANTI, LLP, 600 THIRD AVENUE, NEW YORK, NY, 10016, US

(21) Appl. No.: 10/113,354

(22) Filed: Apr. 1, 2002

(51) Int. Cl. H04M 1/64; H04M 3/00

(52) U.S. Cl. 379/265.02; 379/88.25

(57) ABSTRACT

Interactive telephone reply system, which is comprised of a telephone line interface, a digitaliser, a recognition module and a programmed computer; at least one recording module; at least one output warehouse, which accumulates the replies of the physical operator so that the interactive conversation is not interrupted; at least one work management program for physical operators or work queue in an input warehouse; at least one limiter that retains the admission of incoming calls when there is operator saturation; at least one multi-level operator, who can transcribe more than one concept in a reply at the same time; and at least one informed operator, with access to historical data about previous information.

For application in the field of telephone communications.

The aim of the invention is for users to be able to hold an automatic conversation with the speaking robot (interactive telephone reply system), even though the robot has not being able to automatically interpret the user's reply, recognising the content of the expression that the user used, or even though the robot has not foreseen recognising this reply.

In traditional technology, when the user enters a similar situation to the two situations mentioned above, the conversation is interrupted waiting for the physical operator to interpret the reply so that, when the robot knows it, it is able to continue the conversation, accordingly.

The interactive telephone reply system according to the invention substantially improves the current technology, preventing the conversation from being interrupted when the help of the physical operator is required, and also continuing with other parts of the conversation, in such a way that during the conversation with the user, the physical operator carries out the transcription of the audio that reaches him, parallel to the conversation that is taking place. The system recovers the reply that the physical operator provides, when it needs this information to be able to continue with the rest of the conversation.

Thus, the user, who is dialoguing with the system, does not notice any break in the conversation, although part of this has been transcribed by the physical operator. This functionality in the current memory is called differed operator.

The system, according to the invention, has also foreseen, in agreement with the above:

a) The preparation of a work management program for physical operators, or work queues. Thus, when a user dialoguing with the system requires the attention of the physical operator, but this physical operator is occupied carrying out a transcription work for another user, the work that the first user generates is left waiting in a work queue until it passes it on to the physical user when he finishes the previous work.

b) An important property has been added to the previous queue management whereby, if the number of jobs that a group of physical operators still have to carry out is high, the incoming calls are limited to avoid excessive delays in the execution of the work. This functionality in this report is called operator saturation.

c) In current technology, a physical operator can only transcribe one concept of the user's reply. The fact that a physical operator can transcribe more than one concept in each reply at the same time is also included as a novelty of this invention. This functionality in this report is called multi-level operator.

d) The possibility of the physical operator, when carrying out his transcription work of the recorded audio, being able to have previous information about user data, system data or data of the conversation that the user has previously carried out, on his computer screen, has also been included, so that he can carry out his transcription work with more information and propriety. This functionality, in this report, is called informed operator.

To understand the object of this invention better, a preferential form of practical execution is illustrated in the drawings, subject to accessory changes that take nothing away from the basis.

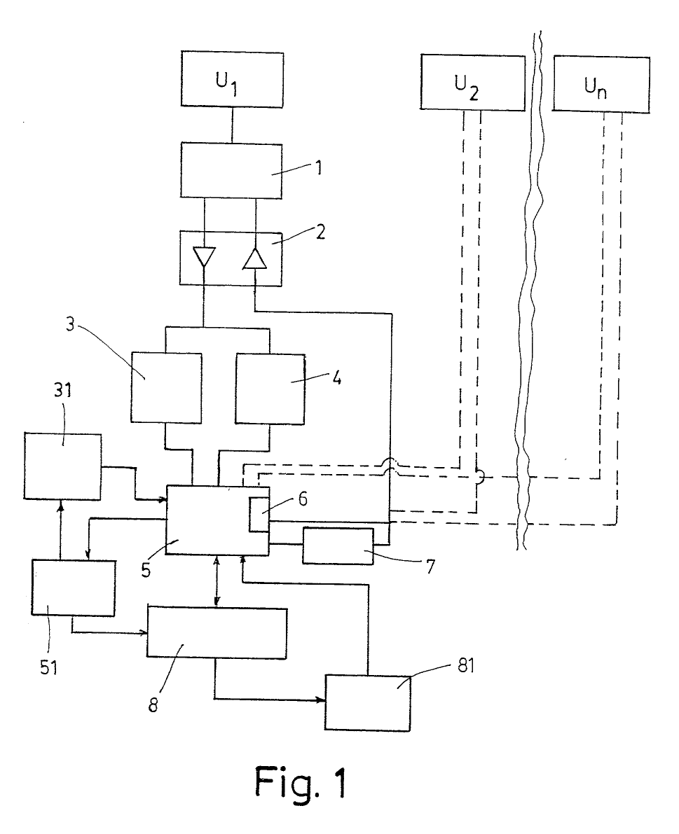

FIG. 1 is a block diagram of the interactive telephone reply system, targeted by the invention.

Below a, non-limitative, example of practical execution of this invention is described.

The system allows several speakers-users (U₁), (U₂), (Uₙ) to establish a communication and talk to it at the same time. The operation of the system is explained respect to one of the users (U₁) and can be extended to the rest.

User (U₁) connects to the system by telephone for which the system has an interface (1) already known, which sends its output signals to a digitaliser (2) if it were necessary to digitalise the signal.

The elements that the system has to recognise by program are qualitatively and quantitatively established for each application, and sometimes this is sufficient for the system to hold a normal conversation in a specific application.

But in other applications, one/some of the elements of the user's reply are complex, due to the way this reply is expressed, due to the unforeseen content of the reply, or due to the background noise that accompanies it.

That is, the system knows its limitations.

In an interactive system-user conversation, guided and aided by the system, the system knows, for example, what the user's answers to certain questions are, which the robot is not programmed to recognise.

After giving these explanations, we proceed with the block diagram of FIG. 1.

The signals sent from the digitaliser (2) are sent to a recognition module (3) and to a digital recording module (4).

For the non-complex phase of the conversation, a microprocessor (5) programmed for an indicated application, after receiving the signals from the recognition module (3) and recording module (4), prepares the answer/reply and sends it to the user (U₁), by means of a recorded voice block (6) or a voice synthesiser (7).

With respect to questions, which the system, the microprocessor (5) knows beforehand, by program, for which it is not going to recognise the user's replies, the microprocessor (5) orders the reply to be recorded in the recording module (4) and passes it to an “input warehouse” (51) so that the interactive conversation is not interrupted, but instead it continues with other parts of the conversation, in such a way that during the conversation with the user (U₁), the physical operator (8) makes the transcription of the audio that reaches him, parallel to the conversation that is continuing. The system recovers the reply—which the physical operator (8) provides and has placed in an output warehouse (81)—when it needs this information to be able to continue with the rest of the conversation.

In this way, the user (U₁) that is dialoguing with the system, does not observe any break in the conversation, although part of it has been transcribed by the physical operator (8). This functionality is called differed operator.

In practice, the route—recording module (4), microprocessor (5), physical operator (8), microprocessor (5), user (U₁)—represents a time of between 1 and 30 seconds, so the pauses in the conversation can be considered as acceptable.

Notwithstanding the above, the system, according to the invention, has foreseen:

a) The preparation of a work management program for physical operator (8), or work queues. Thus, when a user (U₁) in dialogue with the system requires the attention of the physical operator (8), but the latter is occupied carrying out transcription work for another user (U₂), the work, which the first user generates, is left in a work queue to pass it on to a physical operator when the latter finishes the previous work.

b) An important property has been added to the previous work management for queues whereby, if the number of jobs that a group of physical operators (9) still have to do is high, the incoming calls are limited (31) to avoid excessive delays in the execution of the work. This functionality is called operator saturation.

c) An addition to this previous management is included, where the physical operator (8) can only transcribe one concept of the user's reply, which is that the physical operator (8) can transcribe more than one concept of the reply, that is, several concepts at the same time. This functionality is called multi-level operator.

d) Another addition to the previous aspects is the possibility of the physical operator (8), when carrying out his transcription work of the recorded audio, being able to have previous information about user date, system data, or data of the conversation that the user has held previously, on his computer screen, so that he can do his transcription work with more information and propriety. This functionality is called informed operator.

1.- Interactive telephone reply system, characterised because, comprising a telephone line interface, a digitaliser, a recognition module and a computer programmed to hold a predetermined conversation with at least one user, it is also comprised of:
a) at least one recording module, where the user's replies to a preset series of questions to be asked by the microprocessor are recorded, passing the recorded information to a physical operator, who transcribes its content and encodes its reply, typing this in a way that the microprocessor, which continues the conversation, can recognise;
b) at least one output warehouse, which accumulates the replies of the physical operator, so that the interactive conversation is not interrupted but continues with other parts of the conversation;
c) at least one queue management program for physical operator;
d) at least one limiter that retains the admission of incoming calls to the interactive telephone reply system, when there is operator saturation;
e) at least one-multi-level operator, who can transcribe more than one concept in a reply at the same time;
f) at least one informed operator, with access to historical data of previous information referring to the user, to previous conversations or data of the system itself.
